(19) United States
(12) Patent Application Publication
(10) Pub. No.: US 2026/0196939 A1
(43) Pub. Date: Jul. 9, 2026

(54) MULTIPHASE SWITCHING CONVERTERS WITH PHASE DUPLICATION

(71) Applicant: Chengdu Monolithic Power Systems Co., Ltd., Chengdu (CN)

(72) Inventors: Wangmiao Hu, Hangzhou (CN); Fangyu Zhang, Hangzhou (CN); Ming Chen, Hangzhou (CN)

(21) Appl. No.: 19/440,186

(22) Filed: Jan. 5, 2026

(30) Foreign Application Priority Data
Jan. 6, 2025 (CN) 202510014541.8

(51) Int. Cl. H02M 3/158

(52) U.S. Cl. CPC H02M 3/1586

(57) ABSTRACT

A controller for a multiphase switching converter has a turn-on control circuit and a switch control circuit. The turn-on control circuit provides a turn-on control signal based on a voltage sensing signal and a voltage reference signal. The switch control circuit generates a plurality of switch control signals based on the turn-on control signal and a plurality of current sensing signals. The switch control circuit regulates a plurality of switching circuits to operate in n groups, with each group comprising k switching circuits that are turned on at the same time, where n and k are integers greater than one. The switch control circuit sequentially turns on the n groups of switching circuits in response to pulses of the turn-on control signal.

### CROSS-REFERENCE TO RELATED APPLICATIONS

This application claims the benefit of CN application 202510014541.8, filed on Jan. 6, 2025, and incorporated herein by reference.

### BACKGROUND OF THE INVENTION

### 1. Field of the Invention

The present invention generally relates to electronic circuits, and more particularly but not exclusively relates to multiphase switching converters.

### 2. Description of Related Art

In recent years, with the emergence of high-performance processors, there has been a growing need for power supply systems that can provide smaller output voltages and larger output currents. Additionally, the requirements for thermal performance and transient response performance have also become increasingly stringent. Multiphase switching converters, with their superior performance, have gained widespread adoption. A multiphase switching converter typically comprises a plurality of switching circuits, each representing one phase, and the outputs of these switching circuits are coupled together to provide a stable output voltage to the load. However, as the power requirements of loads continue to increase, designing multiphase switching converters that can meet the performance demands during load changes has become a significant challenge.

### SUMMARY OF THE INVENTION

It is one of the objects of the present invention to provide a controller and a multiphase switching converter.

One embodiment of the present invention discloses a controller for a multiphase switching converter. The controller comprises a turn-on control circuit and a switch control circuit. The turn-on control circuit is configured to provide a turn-on control signal based on a voltage sensing signal representative of an output voltage of the multiphase switching converter and a voltage reference signal. The switch control circuit is configured to generate a plurality of switch control signals to control the plurality of switching circuits based on the turn-on control signal and a plurality of current sensing signals representative of a plurality of currents flowing through a plurality of switching circuits of the multiphase switching converter. The switch control circuit is configured to regulate the plurality of switching circuits to operate in n groups, with each group comprising k switching circuits that are turned on at the same time, where n and k are integers greater than one. The switch control circuit sequentially turns on the n groups of switching circuits in response to pulses of the turn-on control signal.

Another embodiment of the present invention discloses a controller for a multiphase switching converter. The controller comprises a memory, a turn-on control circuit, and a switch control circuit. The memory is configured to provide a mode enable signal. The turn-on control circuit is configured to provide a turn-on control signal based on an output voltage of the multiphase switching converter and a voltage reference signal. The switch control circuit is configured to provide a plurality of switch control signals to control a plurality of switching circuits of the multiphase switching converter based on the mode enable signal and the turn-on control signal. In response to a first status of the mode enable signal, the switch control circuit is configured to regulate the plurality of switching circuits to operate in n groups that are turned on in sequence based on the turn-on control signal, with each group comprising k switching circuits that are turned on at the same time, where n and k are integers greater than one.

Yet another embodiment of the present invention discloses a multiphase switching converter. The multiphase switching converter comprises an input terminal, an output terminal, a plurality of switching circuits, a turn-on control circuit, and a switch control circuit. The input terminal is configured to receive an input voltage. The output terminal is configured to provide an output voltage. The plurality of switching circuits are coupled in parallel between the input terminal and the output terminal, for converting the input voltage to the output voltage. The turn-on control circuit is configured to provide a turn-on control signal based on a voltage sensing signal representative of the output voltage and a voltage reference signal. The switch control circuit is configured to generate a plurality of switch control signals based on the turn-on control signal and a plurality of current sensing signals representative of a plurality of currents flowing through a plurality of switching circuits of the multiphase switching converter. The switch control circuit is configured to partition the plurality of switch control signals into n groups, each comprising k switch control signals, where n and k are integers greater than one, the n groups of switch control signals regulate the plurality of switching circuits to operate in n groups, with each group comprising k switching circuits. In response to pulses of the turn-on control signal, the switch control circuit sequentially turns on the n groups of switching circuits, and furthermore turns on the k switching circuits within each group simultaneously.

These and other features of the present invention will be readily apparent to persons of ordinary skill in the art upon reading the entirety of this disclosure, which comprises the accompanying drawings and claims.

### BRIEF DESCRIPTION OF DRAWINGS

The present invention can be further understood with reference to the following detailed description and the appended drawings, wherein like elements are provided with like reference numerals.

FIG. 1 schematically shows a multiphase switching converter 100 in accordance with an embodiment of the present invention.

FIG. 2 shows waveforms of the multiphase switching converter 100 in accordance with an embodiment of the present invention.

FIG. 3 shows waveforms of the multiphase switching converter 100 in accordance with another embodiment of the present invention.

FIG. 4 schematically shows a switch control circuit 22 in accordance with an embodiment of the present invention.

FIG. 5 schematically shows a turn-off control unit 222 in accordance with an embodiment of the present invention.

FIG. 6 schematically shows a multiphase switching converter 600 in accordance with an embodiment of the present invention.

FIG. 7 schematically shows a switching circuit 62_1 in accordance with an embodiment of the present invention.

FIG. 8 schematically shows a controller 61 in accordance with an embodiment of the present invention.

FIG. 9 schematically shows a diagram of a turn-on mode register 900 in accordance with an embodiment of the present invention.

FIG. 10 schematically shows a switch control circuit 610 in accordance with an embodiment of the present invention.

FIG. 11A shows waveforms of the multiphase switching converter 600 in a steady state when a group turn-on mode is enabled in accordance with an embodiment of the present invention.

FIG. 11B shows waveforms of the multiphase switching converter 600 during transients when the group turn-on mode is enabled in accordance with an embodiment of the present invention.

FIG. 12A shows waveforms of the multiphase switching converter 600 in the steady state when the group turn-on mode is disabled in accordance with an embodiment of the present invention.

FIG. 12B shows waveforms of the multiphase switching converter 600 during transients when the group turn-on mode is disabled in accordance with an embodiment of the present invention.

FIG. 13 illustrates a control method 130 for a multiphase switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

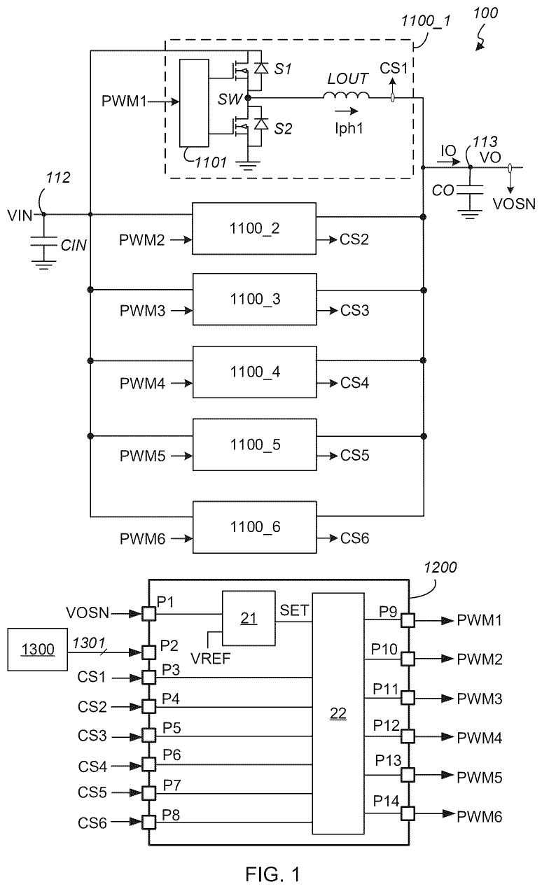

FIG. 1 schematically shows a multiphase switching converter 100 in accordance with an embodiment of the present invention. The multiphase switching converter 100 receives an input voltage VIN at its input terminal 112 and provides an output voltage VO and an output current IO to a load (e.g., a processor) at its output terminal 113.

The multiphase switching converter 100 comprises a plurality of switching circuits (1100_1-1100_6 as shown in FIG. 1) coupled in parallel between the input terminal 112 and the output terminal 113, and each switching circuit forms a phase of the multiphase switching converter 100. In the example of FIG. 1, each switching circuit 1100 comprises a driver 1101, a pair of power switches S1 and S2, and an output inductor LOUT. Under control of a plurality of switch control signals PWM1-PWM6, the switching circuits 1100_1-1100_6 convert the input voltage VIN to the output voltage VO. For example, the switching circuit 1100_1 is turned on and off by the switch control signal PWM1, the switching circuit 1100_2 is turned on and off by the switch control signal PWM2, and so on. Taking the switching circuit 1100_1 as an example, when the switch control signal PWM1 is in a first state (e.g., logic high), the switching circuit 1100_1 is turned on, e.g., the power switch S1 of the switching circuit 1100_1 is turned on, the power switch S2 of the switching circuit 1100_1 is turned off, and a switch node SW formed by the power switches S1 and S2 is electrically connected to the input terminal 112. When the switch control signal PWM1 is in a second state (e.g., logic low), the switching circuit 1100_1 is turned off, e.g., the power switch S1 of the switching circuit 1100_1 is turned off, the power switch S2 of the switching circuit 1100_1 is turned on, and the switching node SW is electrically connected to a reference ground. One end of the output inductor LOUT is electrically connected to the switch node SW, and the other end of the output inductor LOUT is electrically connected to the output terminal 113. In one embodiment, a voltage level between a high threshold voltage (e.g., 2V) and a power supply voltage (e.g., 3.3V) is considered logic high, and a voltage level between zero volts (0V) and a low threshold voltage (e.g., 1V) is considered logic low. FIG. 1 shows six switching circuits as an example, but those skilled in the art will understand that the number of the switching circuits can be greater or less than six.

The multiphase switching converter 100 also comprises a controller 1200. The controller 1200 provides the switch control signals PWM1-PWM6 based on the output voltage VO and currents flowing through the switching circuits 1100_1-1100_6. In one embodiment, the controller 1200 divides the switching circuits 1100_1-1100_6 into multiple groups, each group comprises at least two switching circuits. The switching circuits in the same group are turned on at the same time. The controller 1200 successively turns on the switching circuits in different groups, e.g., as an interleave manner. In one embodiment, the controller 1200 provides three groups switch control signals to divide the switching circuits 1100_1-1100_6 into three groups, with each group comprising two switching circuits that are turned on at the same time. For example, a first group switch control signals PWM1 and PWM2 simultaneously turn on a first group switching circuits 1100_1 and 1100_2, a second group switch control signals PWM3 and PWM4 simultaneously turn on a second group switching circuits 1100_3 and 1100_4, and a third group switch control signals PWM5 and PWM6 simultaneously turn on a third group switching circuits 1100_5 and 1100_6. The three groups switching circuits are successively turned on, e.g., after the first group switching circuits 1100_1 and 1100_2 are turned on and after a first delay, the second group switching circuits 1100_3 and 1100_4 are turned on, and then after a second delay, the third group switching circuits 1100_5 and 1100_6 are turned on. After that the first group switching circuits 1100_1 and 1100_2 are turned on again, and this process is repeated. In another embodiment, the controller 1200 can also provide two groups switch control signals to divide the switching circuits 1100_1-1100_6 into two groups, with each group comprising three switching circuits that are turned on at the same time. For example, the first group switch control signals PWM1-PWM3 simultaneously turn on the first group switching circuits 1100_1-1100_3, and the second group switch control signals PWM4-PWM6 simultaneously turn on the second group switching circuits 1100_4-1100_6. The two groups switching circuits are successively turned on, e.g., after the first group switching circuits 1100_1-1100_3 are turned on and after a first delay, the second group switching circuits 1100_4-1100_6 are turned on. After that the first group switching circuits 1100_1-1100_3 are turned on again, and this process is repeated.

In one embodiment, the controller 1200 is integrated into a single integrated circuit (IC) that has a voltage sensing pin P1, a communication pin P2, a plurality of current sensing pins P3-P8, and a plurality of switch control pins P9-P14. The voltage sensing pin P1 receives a voltage sensing signal VOSN that represents the output voltage VO. The communication pin P2 is coupled to a system controller 1300 through a communication bus 1301, e.g., to receive control commands from the system controller 1300 to program operating parameters of the multiphase switching converter 100 (such as a switching frequency, the output voltage VO, an operation mode et. al). The current sensing pin P3 receives a current sensing signal CS1 that represents a phase current Iph1 flowing through the switching circuit 1100_1. Similarly, the current sensing pins P4-P8 receive current sensing signals CS2-CS6, which represent the phase currents flowing through the corresponding switching circuits 1100_2-1100_6. The switch control pins P9-P14 provide the switch control signals PWM1-PWM6.

In one embodiment, the controller 1200 comprises a turn-on control circuit 21 and a switch control circuit 22. The turn-on control circuit 21 is coupled to the voltage sensing pin P1 and provides a turn-on control signal SET based on the voltage sensing signal VOSN and a voltage reference signal VREF. The turn-on control signal SET has a plurality of pulses. In one embodiment, when the voltage sensing signal VOSN is less than the voltage reference signal VREF, the turn-on control circuit 21 outputs a pulse of the turn-on control signal SET.

The switch control circuit 22 is coupled to the turn-on control circuit 21 to receive the turn-on control signal SET, coupled to the current sensing pins P3-P8 to receive the current sensing signals CS1-CS6, and coupled to the switch control pins P9-P14 to provide the switch control signals PWM1-PWM6. The switch control circuit 22 generates the switch control signals PWM1-PWM6 based on the turn-on control signal SET and the current sensing signals CS1-CS6. The switch control signals PWM1-PWM6 control the switching circuits 1100_1-1100_6 to operate in n groups, each group comprising k switching circuits that are turned on simultaneously. Here, n and k are natural numbers greater than 1. The switch control circuit 22 controls the n groups of switching circuits to turn on sequentially based on the pulses of the turn-on control signal SET, to regulate the output voltage VO at a voltage setpoint. The controller 1200 provides the voltage reference signal VREF based on the voltage setpoint. The switch control circuit 22 turns off each switching circuit 1100_1-1100_6 individually based on the current sensing signals CS1-CS6, to regulate the current flowing through each switching circuit. For example, the switching circuits 1100_1-1100_6 can be divided into three groups, each group comprising two switching circuits, or the switching circuits 1100_1-1100_6 can be divided into two groups, each group comprising three switching circuits.

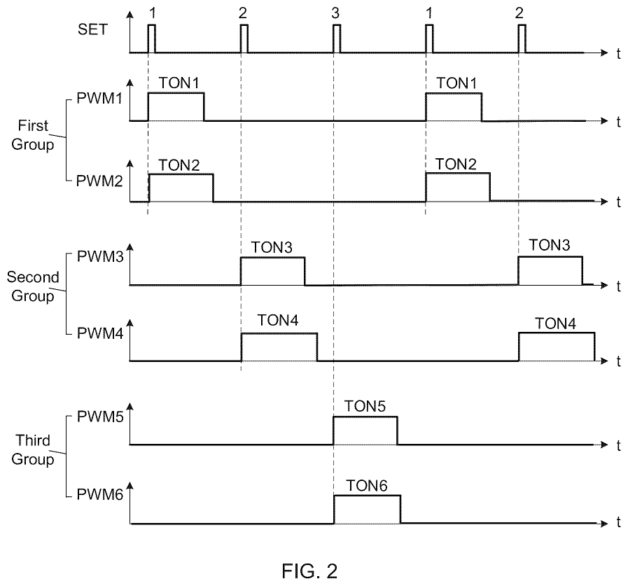

FIG. 2 shows waveforms of the multiphase switching converter 100 in accordance with an embodiment of the present invention. From top to bottom, FIG. 2 shows the turn-on control signal SET and the switch control signals PWM1-PWM6. In the example of FIG. 2, the plurality of switching circuits 1100_1-1100_6 operate in three groups, each group comprising two switching circuits.

The plurality of pulses of the turn-on control signal SET successively control the plurality of groups of switch control signals to the first state (e.g., logic high) one after another. As shown in FIG. 2, pulses labelled as “1” control rising edges of the first group switch control signals PWM1 and PWM2, to turn on the switching circuits 1100_1 and 1100_2 simultaneously. Pulses labelled as “2” control rising edges of the second group switch control signals PWM3 and PWM4, to turn on the switching circuits 1100_3 and 1100_4 simultaneously. Pulses labelled as “3” control rising edges of the third group switch control signals PWM5 and PWM6, to turn on the switching circuits 1100_5 and 1100_6 simultaneously. This process is repeated. Thus, each group of the switching circuits is successively turned on, one after another. The rising edges of the two switch control signals in each group are mutually aligned, so that the two switching circuits in each group are turned on simultaneously, without being limited by a minimum ON-time period. For example, the switching circuits 1100_1 and 1100_2 are turned on simultaneously, and the switching circuit 1100_2 does not need to wait until the minimum ON-time period of the switching circuit 1100_1 has elapsed before turning on. Therefore, an equivalent duty cycle of the multiphase switching converter 100 during transients is increased, and a capability of handling a large current is improved.

Further, the switch control circuit 22 controls the falling edges of the switch control signal PWM1 based on the current sensing signal CS1, to turn off the switching circuit 1100_1, thereby adjusting an ON-time period TON1 of the switching circuit 1100_1 and regulating the current flowing through the switching circuit 1100_1. Similarly, the switch control circuit 22 controls the falling edges of the switch control signals PWM2-PWM6 based on the current sensing signals CS2-CS6, to turn off the switching circuits 1100_2-1100_6 respectively, thereby adjusting corresponding ON-time periods TON2-TON6 of the switching circuits 1100_2-1100_6 and regulating the currents flowing through the switching circuits 1100_2-1100_6.

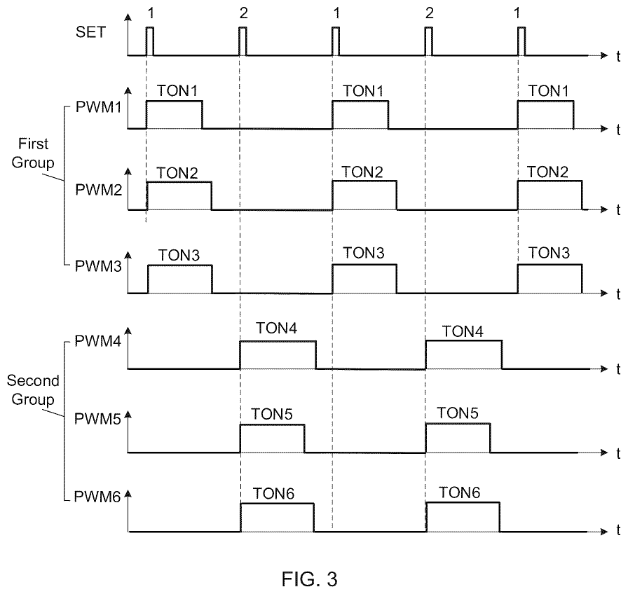

FIG. 3 shows waveforms of the multiphase switching converter 100 in accordance with another embodiment of the present invention. From top to bottom, FIG. 3 shows the turn-on control signal SET and the switch control signals PWM1-PWM6.

Different from the embodiment shown in FIG. 2, in the embodiment shown in FIG. 3, the plurality of switching circuits 1100_1-1100_6 operate in two groups, each group comprising three switching circuits. As shown in FIG. 3, the pulses labelled as “1” control rising edges of the first group switch control signals PWM1-PWM3, to turn on the switching circuits 1100_1-1100_3 simultaneously. The pulses labelled as “2” control rising edges of the second group switch control signals PWM4-PWM6, to turn on the switching circuits 1100_4-1100_6 simultaneously. This process is repeated. Thus, each group of the switching circuits is successively turned on, one after another. The rising edges of the three switch control signals in each group are mutually aligned, so that the three switching circuits in each group are turned on simultaneously, without being limited by the minimum ON-time period. For example, the switching circuits 1100_1-1100_3 are turned on simultaneously, and the switching circuit 1100_2 does not need to wait until the minimum ON-time period of the switching circuit 1100_1 has elapsed before turning on. Similarly, the switching circuit 1100_3 does not need to wait until the minimum ON-time period of the switching circuit 1100_2 has elapsed before turning on.

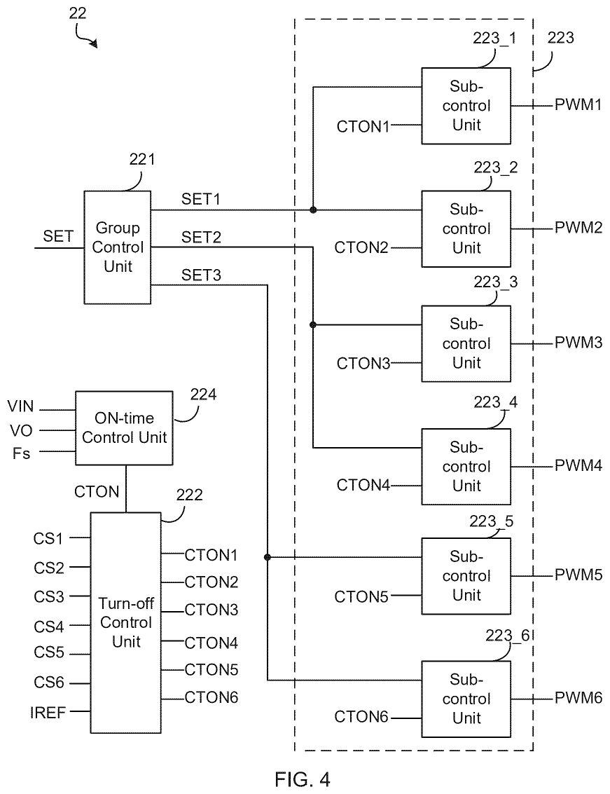

FIG. 4 schematically shows the switch control circuit 22 in accordance with an embodiment of the present invention. The switch control circuit 22 comprises a group control unit 221, a turn-off control unit 222, a switch control unit 223 and an ON-time control unit 224. The switch control unit 223 comprises a plurality of sub-control units 223_1-223_6. The embodiment shown in FIG. 4 exemplifies the operation of dividing the plurality of switching circuits 1100_1-1100_6 into three groups.

The group control unit 221 generates n group control signals based on the turn-on control signal SET, sequentially distributing the pulses of the turn-on control signal SET to the n group control signals. In the embodiment shown in FIG. 4, the group control unit 221 generates three group control signals SET1-SET3 and sequentially distributes the pulses of the turn-on control signal SET to the group control signals SET1-SET3. Each group control signal controls the rising edges of the switch control signals in the same group, thereby simultaneously turning on the switching circuits in the same group.

The ON-time control unit 224 provides a preset ON-time control signal CTON. The preset ON-time control signal CTON is used to control an initial ON-time period TON of each switching circuit. In one embodiment, the preset ON-time control signal CTON can be obtained based on the input voltage VIN, the output voltage VO (or the output voltage setpoint), and a preset switching frequency Fs. The turn-off control unit 222 is coupled to the current sensing pins P3-P8 to receive the current sensing signals CS1-CS6, and provides turn-off control signals CTON1-CTON6 based on the current sensing signals CS1-CS6, a current reference signal IREF, and the preset ON-time control signal CTON. Each of the turn-off control signals CTON1-CTON6 regulates the current flowing through the corresponding switching circuit by adjusting a turn-off time of the corresponding switching circuit. For example, based on the difference between the current sensing signal CS1 and the current reference signal IREF, the turn-off control signal CTON1 is generated on basis of the preset ON-time control signal CTON. This controls the falling edges of the switch control signal PWM1, thereby extending or shortening the ON-time period of the switching circuit 1100_1 on basis of the initial ON-time period TON. The ON-time periods of the switching circuits 1100_2-1100_6 are controlled in the same way. In some examples, the current reference signal IREF may be equal to the current sensing signal of one of the switching circuits, or may be equal to an average value representing the currents flowing through all the switching circuits, or may be obtained based on a sum of the currents flowing through all the switching circuits. In another embodiment, the current reference signal IREF may be specified by a value written by a user to a relevant register.

The switch control unit 223 generates a plurality of switch control signals PWM1-PWM6 based on the group control signals SET1-SET3 and the plurality of turn-off control signals CTON1-CTON6. The group control signal SET1 controls the rising edges of the first group switch control signals PWM1-PWM2, thereby turning on the switching circuits 1100_1-1100_2 simultaneously in response to the pulses of the group control signal SET1. The turn-off control signal CTON1 controls the falling edges of the switch control signal PWM1, thereby controlling the turn-off time of the switching circuit 1100_1. The turn-off control signal CTON2 controls the falling edges of the switch control signal PWM2, thereby controlling the turn-off time of the switching circuit 1100_2. The group control signal SET2 controls the rising edges of the second group switch control signals PWM3-PWM4, thereby turning on the switching circuits 1100_3-1100_4 simultaneously in response to the pulses of the group control signal SET2. The turn-off control signal CTON3 controls the falling edges of the switch control signal PWM3, thereby controlling the turn-off time of the switching circuit 1100_3. The turn-off control signal CTON4 controls the falling edges of the switch control signal PWM4, thereby controlling the turn-off time of the switching circuit 1100_4. The group control signal SET3 controls the rising edges of the third group switch control signals PWM5-PWM6, thereby turning on the switching circuits 1100_5-1100_6 simultaneously in response to the pulses of the group control signal SET3. The turn-off control signal CTON5 controls the falling edges of the switch control signal PWM5, thereby controlling the turn-off time of the switching circuit 1100_5. The turn-off control signal CTON6 controls the falling edges of the switch control signal PWM6, thereby controlling the turn-off time of the switching circuit 1100_6.

As shown in FIG. 4, the switch control unit 223 comprises, for example, the sub-control units 223_1-223_6. The sub-control unit 223_1 receives the group control signal SET1 and the turn-off control signal CTON1, and generates the switch control signal PWM1 based on the group control signal SET1 and the turn-off control signal CTON1. The sub-control unit 223_2 receives the group control signal SET1 and the turn-off control signal CTON2, and generates the switch control signal PWM2 based on the group control signal SET1 and the turn-off control signal CTON2. The sub-control unit 223_3 receives the group control signal SET2 and the turn-off control signal CTON3, and generates the switch control signal PWM3 based on the group control signal SET2 and the turn-off control signal CTON3. The sub-control unit 223_4 receives the group control signal SET2 and the turn-off control signal CTON4, and generates the switch control signal PWM4 based on the group control signal SET2 and the turn-off control signal CTON4. The sub-control unit 223_5 receives the group control signal SET3 and the turn-off control signal CTON5, and generates the switch control signal PWM5 based on the group control signal SET3 and the turn-off control signal CTON5. The sub-control unit 223_6 receives the group control signal SET3 and the turn-off control signal CTON6, and generates the switch control signal PWM6 based on the group control signal SET3 and the turn-off control signal CTON6.

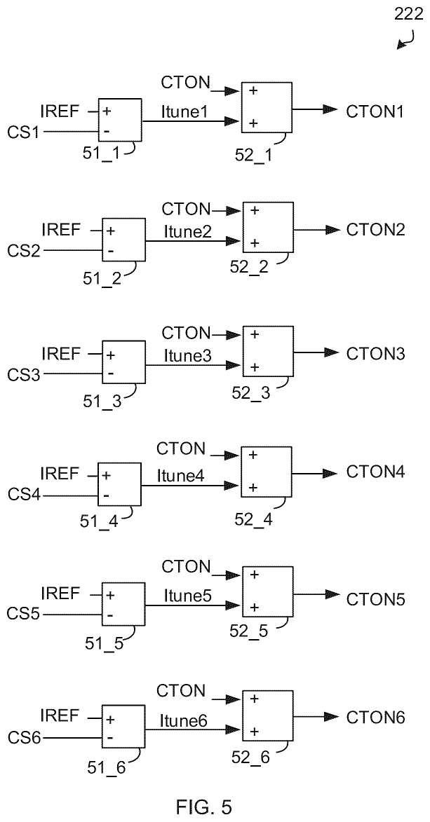

FIG. 5 schematically shows the turn-off control unit 222 in accordance with an embodiment of the present invention. The turn-off control unit 222 generates current regulation signals Itune1-Itune6 respectively based on the differences between the current sensing signals CS1-CS6 and the current reference signal IREF (e.g., IREF-CS1, IREF-CS2, IREF-CS3, IREF-CS4, IREF-CS5, IREF-CS6). The turn-off control unit 222 provides the turn-off control signals CTON1-CTON6 based on the preset ON-time control signal CTON and the current regulation signals Itune1-Itune6, so as to regulate the ON-time periods of the plurality of switching circuits 1100_1-1100_6 respectively by adjusting the falling edges of the switch control signals PWM1-PWM6, thereby controlling the currents flowing through the corresponding switching circuits to equal the current setpoint defined by the current reference signal IREF. Taking generation of the turn-off control signal CTON1 as one example. The current regulation signal Itune1 is generated based on the difference between the current sensing signal CS1 and the current reference signal IREF, and the turn-off control signal CTON1 is generated based on a sum of the current regulation signal Itune1 and the preset ON-time control signal CTON. The turn-off control signals CTON2-CTON6 are generated similarly.

In the embodiment shown in FIG. 5, the turn-off control unit 222 comprises error adjustment units 51_1-51_6 and addition units 52_1-52_6. Error adjustment unit 51_j (j=1, 2 . . . 6) receives the current reference signal IREF and the current sensing signal CSj, and adjusts the error IREF-CSj between the current reference signal IREF and the current sensing signal CSj (e.g., by amplification, proportional integral, or proportional integral derivative adjustment, etc.) to obtain the current regulation signal Itunej. The addition unit 52_j receives the preset ON-time control signal CTON and the current regulation signal Itunej, and provides the turn-off control signal CTONj based on the sum of the preset ON-time control signal CTON and the current regulation signal Itunej.

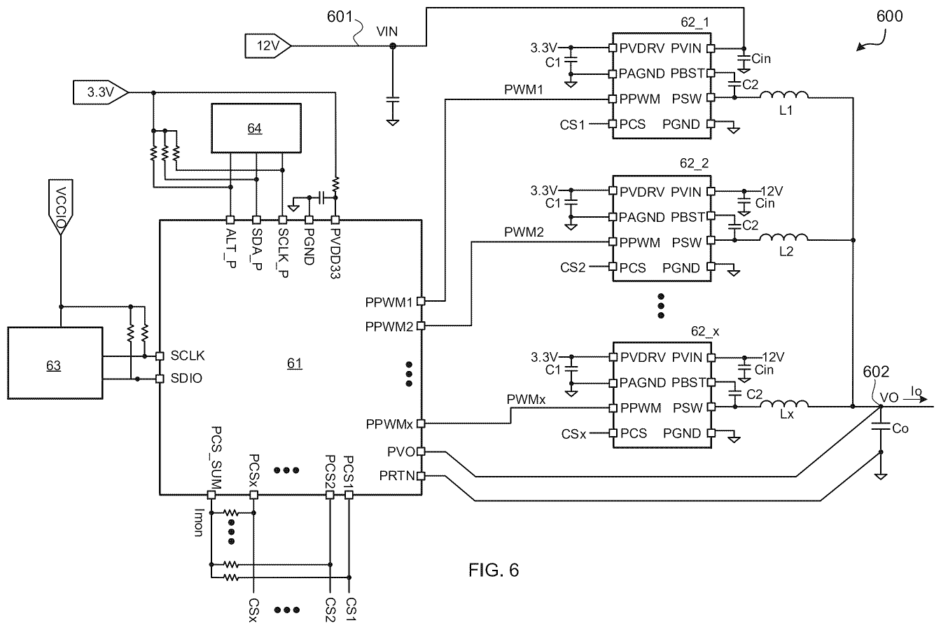

FIG. 6 schematically shows a multiphase switching converter 600 in accordance with an embodiment of the present invention. The multiphase switching converter 600 comprises an input terminal 601, an output terminal 602, a controller 61, a plurality of switching circuits 62_1-62_x, a plurality of output inductors L1-Lx, and an output capacitor Co. Each switching circuit associated with an output inductor forms a phase circuit. The multiphase switching converter 600 has x phases switching circuits as an example, where x is a natural number greater than 4. In the embodiment shown in FIG. 6, the controller 61 is integrated on a control chip, and each switching circuit is integrated on a power chip. The controller 61 provides switch control signals PWM1-PWMx. In one embodiment, the controller 61 may be configured to operate in a group turn-on mode or a non-group turn-on mode. When the controller 61 is configured in the group turn-on mode, the switch control signals PWM1-PWMx control the plurality of switching circuits 62_1-62_x to operate in n groups, with each group comprising k switching circuits, where the product of k and n equals to x. The controller 61 controls the n groups of switching circuits to be turned on sequentially to regulate the output voltage VO to be equal to the output voltage setpoint, and the controller 61 controls k switching circuits in each group to be turned on simultaneously. When the controller 61 is configured in the non-group turn-on mode (i.e., a sequence turn-on mode), the switch control signals PWM1-PWMx control the plurality of switching circuits 62_1-62_x to be turned on sequentially.

As shown in FIG. 6, each power chip comprises a voltage input pin PVIN coupled to the input terminal 601 to receive the input voltage VIN, a switch pin PSW, a bootstrap pin PBST, a logic power supply pin PVDRV receiving a logic power supply, a power reference ground pin PGND coupled to the reference ground, a signal reference ground pin PAGND coupled to the reference ground, a current sensing output pin PCS, and a switch control input pin PPWM. In one embodiment, the input voltage VIN is 12V, and the logic power supply is 3.3 V. A coupling capacitor C1 is electrically connected between the logic power supply pin PVDRV and the signal reference ground pin PAGND, a coupling capacitor C2 is electrically connected between the bootstrap pin PBST and the switch pin PSW, and a coupling capacitor Cin is electrically connected between the voltage input pin PVIN and a reference ground GND. The switch control input pin PPWM receives the corresponding switch control signal, and the current sensing output pin PCS outputs a feedback signal representing the current flowing through the corresponding switching circuit. For example, a feedback signal CS1 represents a current flowing through the switching circuit 62_1, a feedback signal CS2 represents a current flowing through the switching circuit 62_2, and so forth. A feedback signal CSx represents a current flowing through the switching circuit 62_x. The switch pin PSW coupled to the corresponding inductor provides the output voltage VO at the output terminal 602. For example, one end of the inductor L1 is coupled to the switch pin PSW of the power chip where the switching circuit 62_1 is located at, and the other end is coupled to the output terminal 602. Similarly, one end of the inductor Lx is coupled to the switch pin PSW of the power chip where the switching circuit 62_x is located at, and the other end is coupled to the output terminal 602. A first end of the output capacitor Co is coupled to the output terminal 602, and A second end of the output capacitor Co is coupled to the reference ground.

The control chip where the controller 61 is located at comprises switch control pins PPWM1-PPWMx for providing switch control signals PWM1-PWMx, current sensing pins PCS1-PCSx for receiving feedback signals CS1-CSx, a total current feedback pin PCS_SUM for receiving a total current feedback signal Imon, a remote voltage feedback pin PVO, and a remote voltage return pin PRTN. The remote voltage feedback pin PVO is coupled to the first end of the output capacitor Co, and the remote voltage return pin PRTN is coupled to the second end of the output capacitor Co. In one embodiment, the control chip further comprises communication pins SCLK and SDIO that can be coupled to a load 63 (e.g., a CPU shown in FIG. 6) through a SVID bus (including a clock bus and a data bus). In the embodiment shown in FIG. 6, the communication pin SCLK is coupled to the clock bus, and the communication pin SDIO is coupled to the data bus. In one embodiment, the control chip further comprises communication pins SCLK_P, SDA_P, and ALT_P that can be coupled to a system controller 64 through a PMBus (including the clock bus, the data bus, and an alert bus). In the embodiment shown in FIG. 6, the communication pin SCLK_P is coupled to the clock bus, the communication pin SDA_P is coupled to the data bus, and the communication pin ALT_P is coupled to the alert bus. In one embodiment, the control chip further comprises a logic power supply pin PVDD33, which is coupled to the logic power supply of 3.3V.

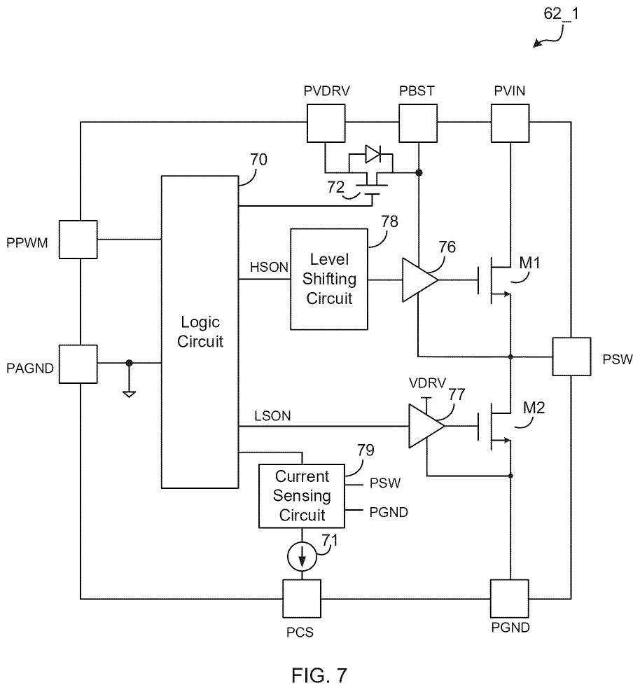

FIG. 7 schematically shows the switching circuit 62_1 in accordance with an embodiment of the present invention. The switching circuit 62_1 is integrated on one chip. FIG. 7 illustrates the switching circuit 62_1 as an example, and those skilled in the art can recognize that the switching circuits 62_2-62_x have the same circuit structure as the switching circuit 62_1. As shown in FIG. 7, the switching circuit 62_1 comprises a high-side switch M1 and a low-side switch M2. A first end of the high-side switch M1 is coupled to the voltage input pin PVIN, a second end of the high-side switch M1 is coupled to the switch pin PSW, and a control end of the high-side switch M1 is coupled to an output terminal of a driving circuit 76. A first end of the low-side switch M2 is coupled to the switch pin PSW, a second end of the low-side switch M2 is coupled to the power reference ground pin PGND, and a control end of the low-end switch M2 is coupled to an output terminal of a driving circuit 77. The bootstrap pin PBST is coupled to the logic power supply pin PVDRV through a switch 72. A logic circuit 70 is coupled to the switch control input pin PPWM and the signal reference ground pin PAGND, and provides a high-side switch control signal HSON and a low-side switch control signal LSON. The high-side switch control signal HSON is configured to control the high-side switch M1 through a level shifting circuit 78 and the driving circuit 76. The low-side switch control signal LSON is configured to control the low-side switch M2 through the driving circuit 77. A current sensing circuit 79 senses a current flowing through the high-side switch M1 or the low-side switch M2, and provides a current sensing signal at the current sensing output pin PCS. In one embodiment, a current source 71 is employed to convert the current sensing signal into a current signal.

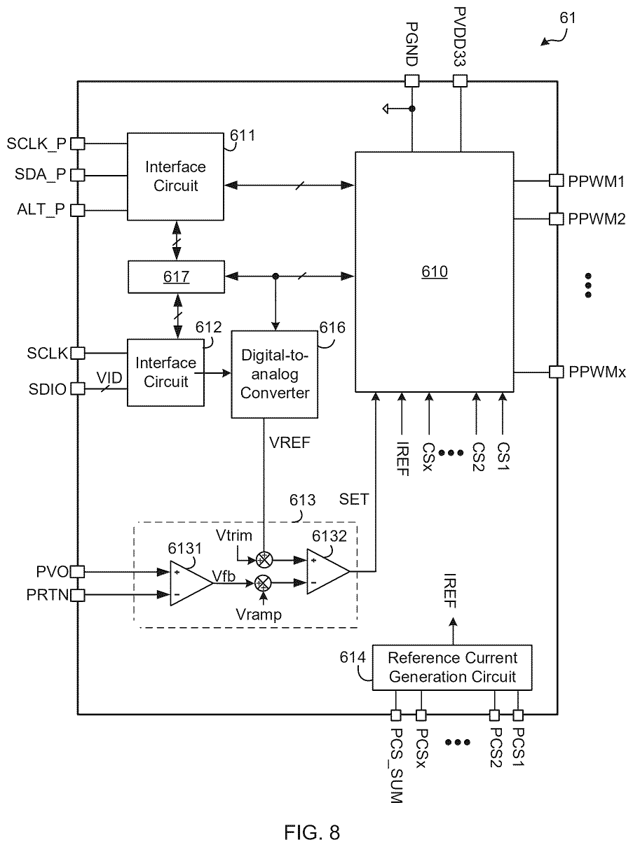

FIG. 8 schematically shows the controller 61 in accordance with an embodiment of the present invention. As shown in FIG. 8, the controller 61 comprises a switch control circuit 610, a turn-on control circuit 613, and a reference current generation circuit 614.

The turn-on control circuit 613 is coupled to the remote voltage feedback pin PVO and the remote voltage return pin PRTN, and provides the turn-on control signal SET based on the voltage between the remote voltage feedback pin PVO and the remote voltage return pin PRTN and the voltage reference signal VREF. For example, the remote voltage feedback pin PVO and the remote voltage return pin PRTN are coupled to input terminals of a differential amplifier 6131 respectively. The differential amplifier 6131 provides a feedback signal Vfb representing the output voltage VO at its output terminal. In one embodiment, the controller 61 generates the turn-on control signal SET based on the feedback signal Vfb and the voltage reference signal VREF, for example, based on comparing the feedback signal Vfb and the voltage reference signal VREF, or based on comparing the feedback signal Vfb, an output calibration signal Vtrim, the voltage reference signal VREF and a ramp signal Vramp. The ramp signal Vramp may be a periodically varying signal, used to enhance system stability, and the output calibration signal Vtrim is used to eliminate a DC static bias between the output voltage VO and the output voltage setpoint. In the embodiment shown in FIG. 8, the turn-on control circuit 613 comprises a comparison circuit 6132. The comparison circuit 6132 provides the turn-on control signal SET based on the sum of the feedback signal Vfb and the ramp signal Vramp and a sum of the voltage reference signal VREF and the output calibration signal Vtrim.

The reference current generation circuit 614 is coupled to the current sensing pins PCS1-PCSx and the total current feedback pin PCS_SUM, and provides the current reference signal IREF. For example, the current reference signal IREF can be provided based on the total current feedback signal Imon, based on any of the current sensing signal, or based on current sensing signals CS1-CSx, etc. The switch control circuit 610 provides the switch control signals PWM1-PWMx to the switch control pins PPWM1-PPWMx based on the turn-on control signal SET, the current sensing signals CS1-CSx and the current reference signal IREF. The switch control circuit 610 turns on the n groups of the switching circuits sequentially based on the pulses of the turn-on control signal SET, and turns off the switching circuits respectively based on the current sensing signals CS1-CSx and the current reference signal IREF. In one embodiment, the switch control circuit 610 can comprise digital control circuits such as a Field-Programmable Gate Array (FPGA), a Microprogrammed Control Unit (MCU), an Application Specific Integrated Circuit (ASIC), etc.

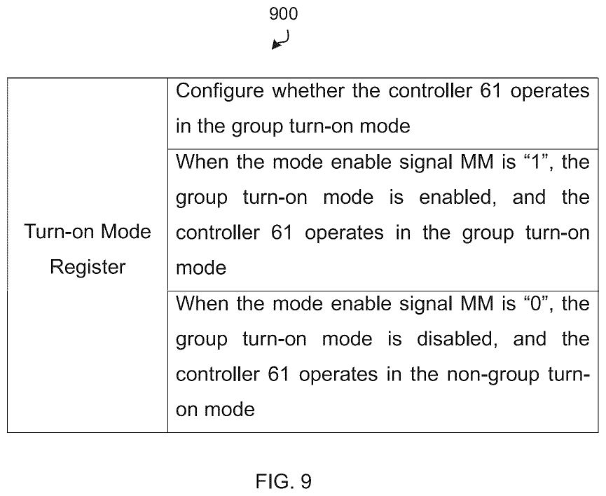

In the embodiment shown in FIG. 8, the controller 61 further comprises a memory 617, an interface circuit 611, and an interface circuit 612. The interface circuit 611 is coupled to the communication pins SCLK_P, SDA_P, and ALT_P. The interface circuit 612 is coupled to the communication pins SCLK and SDIO. In one embodiment, the interface circuit 611 receives control commands from the system controller to configure operating parameters of the multiphase switching converter 600. The interface circuit 611 is coupled to the switch control circuit 610 directly or through the memory 617. In one embodiment, the interface circuit 612 receives a voltage setting data, e.g., a voltage identification code VID. The interface circuit 612 is coupled to the switch control circuit 610 directly or through the memory 617. A digital-to-analog converter 616 provides the voltage reference signal VREF based on the voltage setting data, the data stored in the memory 617, or the data sent by the switch control circuit 610 through digital-to-analog conversion. The memory 617 comprises, for example, a turn-on mode register 900 as shown in FIG. 9.

In one embodiment, the memory 617 configures whether the controller 61 operates in the group turn-on mode. In another embodiment, the system controller 64 can also configure whether the controller 61 operates in the group turn-on mode through the interface circuit 611.

FIG. 9 schematically shows a diagram of the turn-on mode register 900 in accordance with an embodiment of the present invention. The turn-on mode register 900 is used to configure whether the controller 61 operates in the group turn-on mode. In the embodiment shown in FIG. 9, the turn-on mode register 900 provides a mode enable signal MM. When the mode enable signal MM is “1” (i.e., a first status), the group turn-on mode is enabled, and the controller 61 operates in the group turn-on mode. When the mode enable signal MM is “0” (i.e., a second status), the group turn-on mode is disabled, and the controller 61 operates in the non-group turn-on mode.

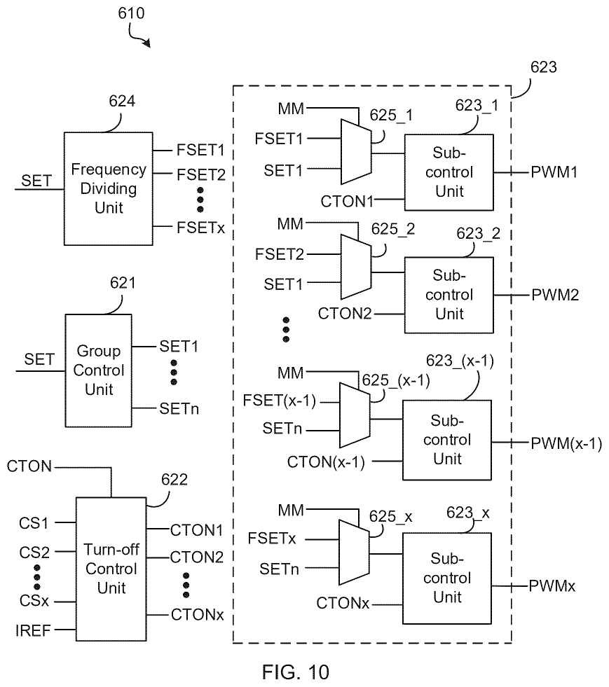

FIG. 10 schematically shows the switch control circuit 610 in accordance with an embodiment of the present invention. In the embodiment shown in FIG. 10, the switch control circuit 610 comprises a group control unit 621, a turn-off control unit 622, a switch control unit 623, and a frequency dividing unit 624.

The group control unit 621 provides n group control signals SET1-SETn based on the turn-on control signal SET, and sequentially distributes the pulses of the turn-on control signal SET to the n group control signals SET1-SETn. Each group control signal is used to control the rising edges of a group of switch control signals, thereby turning on all switching circuits in the same group. The turn-off control unit 622 provides a plurality of turn-off control signals CTON1-CTONx based on the current sensing signals CS1-CSx, the current reference signal IREF, and the preset ON-time control signal CTON. Each of the turn-off control signals CTON1-CTONx is used to control falling edges of the switch control signals PWM1-PWMx to adjust the turn-off time of the corresponding switching circuit, thereby adjusting the current flowing through the corresponding switching circuit. The frequency dividing unit 624 provides a plurality of frequency dividing signals FSET1-FSETx based on the turn-on control signal SET, and sequentially allocates the pulses of the turn-on control signal SET to the x frequency dividing signals FSET1-FSETx. The switch control unit 623 provides the switch control signals PWM1-PWMx based on the mode enable signal MM provided by the register 900, the group control signals SET1-SETn, the frequency dividing signals FSET1-FSETx, and the turn-off control signals CTON1-CTONx.

FIG. 10 illustrates n groups under the group turn-on mode is enabled as an example, each group has two switching circuits. When the mode enable signal MM enables the group turn-on mode, selection units 625_1-625_x select the group control signals SET1-SETn and apply them to sub-control units 623_1-623_x, which then control the rising edges of the corresponding switch control signals PWM1-PWMx. When the mode enable signal MM disables the group turn-on mode, the selection units 625_1-625_x select the frequency dividing signals FSET1-FSETx and apply them to the sub-control units 623_1-623_x, which then control the rising edges of the corresponding switch control signals PWM1-PWMx. The sub-control units 623_1-623_x control the falling edges of the switch control signals PWM1-PWMx respectively based on the turn-off control signals CTON1-CTONx. For example, when the mode enable signal MM enables the group turn-on mode, the sub-control units 623_1 and 623_2 turn on the switching circuits 62_1 and 62_2 simultaneously based on the group control signal SET1, via the switch control signals PWM1 and PWM2. And so forth, the sub-control units 623_(x−1) and 623_x turn on the switching circuits 62_(x−1) and 62_x simultaneously based on the group control signal SETn, via the switch control signals PWM(x−1) and PWMx. When the mode enable signal MM disables the group turn-on mode, the sub-control unit 623_1 provides the switch control signal PWM1 to turn on the switching circuit 62_1 based on the frequency dividing signal FSET1. The sub-control unit 623_2 provides the switch control signal PWM2 to turn on the switching circuit 62_2 based on the frequency dividing signal FSET2, and so forth. The sub-control unit 623_x provides the switch control signal PWMx to turn on the switching circuit 62_x based on the frequency dividing signal FSETx.

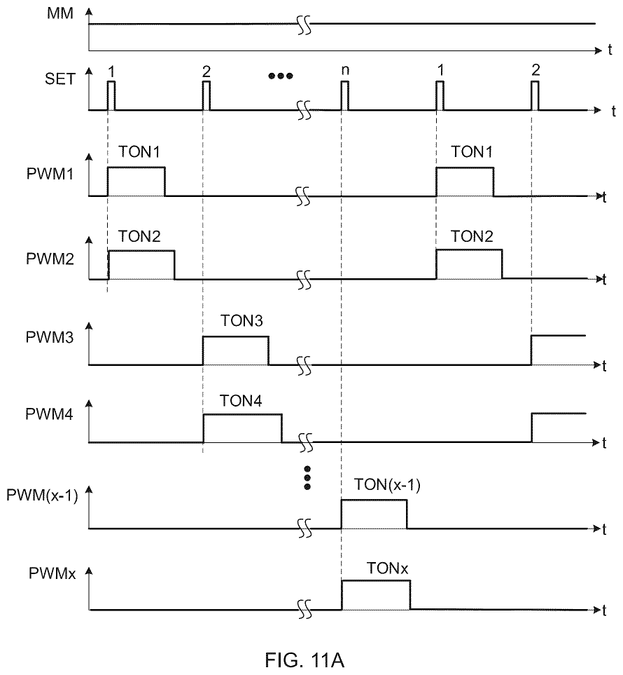

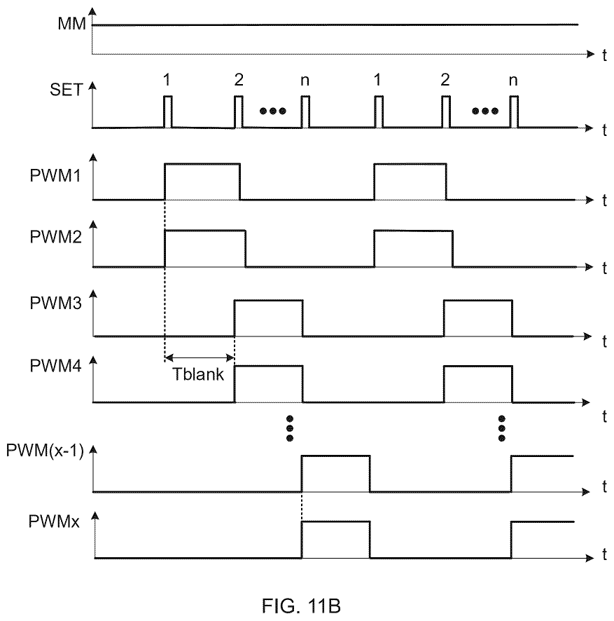

FIG. 11A shows waveforms of the multiphase switching converter 600 in a steady state when the group turn-on mode is enabled in accordance with an embodiment of the present invention. The steady state comprises, for example, the output voltage VO and the output current IO being stable, thereby the switching frequency of the multiphase switching converter 600 is stable. As shown in FIG. 11A, the mode enable signal MM is “1”, and the group turn-on mode is enabled. The example illustrated in FIG. 11A uses two switching circuits in each group for illustration. The pulses of the turn-on control signal SET sequentially turn on the n groups of switching circuits. The pulses labelled as “1” trigger the rising edges of the first group of switch control signals PWM1 and PWM2, to simultaneously turn on the switching circuits 62_1 and 62_2 in the first group. The pulses labelled as “2” trigger the rising edges of the second group of switch control signals PWM3 and PWM4, to simultaneously turning on the switching circuits 62_3 and 62_4 in the second group. And so forth, the pulses labelled as “n” trigger the rising edges of the switch control signals PWM(x−1) and PWMx, to simultaneously turning on the switching circuits 62_(x−1) and 62_x in the n-th group. Where n is equal to x/2, and both n and x are natural numbers.

FIG. 11B shows waveforms of the multiphase switching converter 600 during transients when the group turn-on mode is enabled in accordance with an embodiment of the present invention. The transient state comprises, for example, changes in the output voltage VO and the output current IO due to variations in the load current, the input voltage, etc., and the switching frequency of the multiphase switching converter 600 increases, so that the time interval between pulses of the turn-on control signal SET is reduced. The pulses labelled as “1” trigger the rising edges of the first group of switch control signals PWM1 and PWM2, to simultaneously turn on the switching circuits 62_1 and 62_2 in the first group. After at least a blanking period Tblank, the pulses labelled as “2” trigger the rising edges of the second group of switch control signals PWM3 and PWM4, to simultaneously turning on the switching circuits 62_3 and 62_4 in the second group, and so forth. The blanking period Tblank is the shortest time interval between two successive switching circuits that are turned on in the interleave manner. When the group turn-on mode is enabled, the blanking period Tblank is the time period following turning on of one of the groups of switching circuits, where a subsequent group of switching circuits is blocked from being turned on, to prevent unexpected turning on of the switching circuits. In the group turn-on mode of the embodiment of the present disclosure, turning on the plurality of switching circuits in the same group are not limited by the blanking period Tblank and the minimum ON-time period, and the plurality of switching circuits can have a larger equivalent duty cycle during transients.

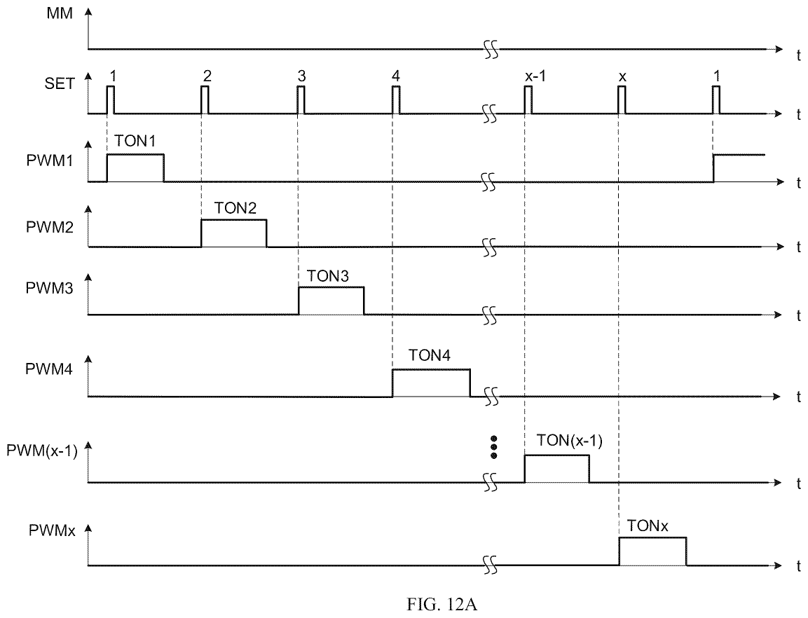

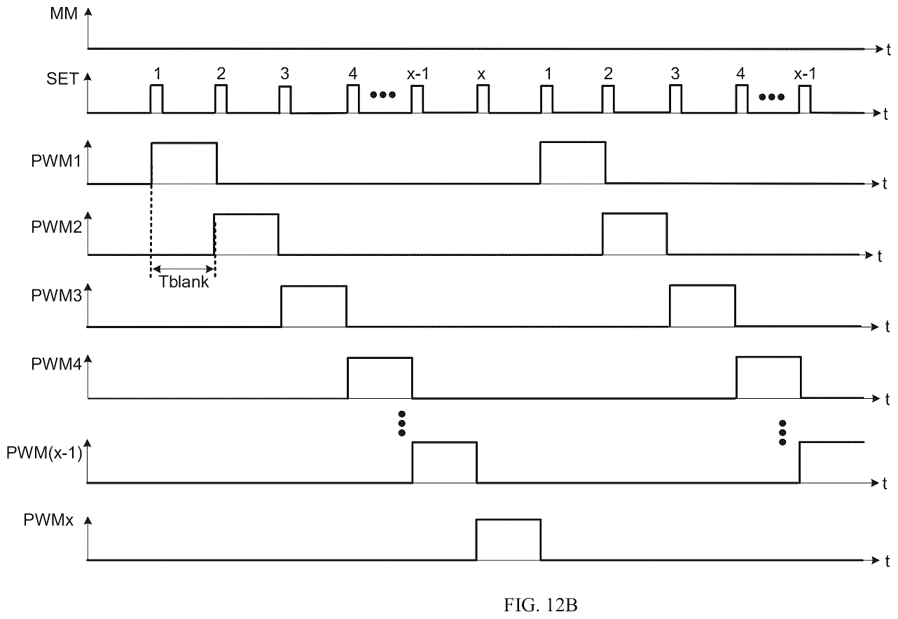

FIG. 12A shows waveforms of the multiphase switching converter 600 in the steady state when the group turn-on mode is disabled in accordance with an embodiment of the present invention. As shown in FIG. 12A, the mode enable signal MM is “0”, and the group turn-on mode is disabled. The pulses of the turn-on control signal SET sequentially turn on the switching circuits. The pulses labelled as “1” trigger the rising edges of the switch control signal PWM1, to simultaneously turn on the switching circuit 62_1. The pulses labelled as “2” trigger the rising edges of the switch control signal PWM2, to simultaneously turn on the switching circuit 62_2. And so forth, the pulses labelled as “x” trigger the rising edges of the switch control signal PWMx, to simultaneously turn on the switching circuit 62_x.

FIG. 12B shows waveforms of the multiphase switching converter 600 during transients when the group turn-on mode is disabled in accordance with an embodiment of the present invention. In the embodiment shown in FIG. 12B, the switch control signals PWM1-PWMx sequentially turn on the switching circuits. When the group turn-on mode is disabled, the blanking period Tblank is the time period following turning on of one of the switching circuits, where a subsequent switching circuit is blocked from being turned on, to prevent unexpected turning on of the switching circuits. During transients as shown in FIG. 12B, the rising edges of the switch control signals PWM1-PWMx are constrained by the blanking period Tblank. For example, when the switch control signal PWM1 transitions to the logic high, the switch control signal PWM2 is prevented from transitioning to the logic high until at least the blanking time Tblank has expired. When the group turn-on mode is disabled, the equivalent duty cycle is limited by the blanking period Tblank.

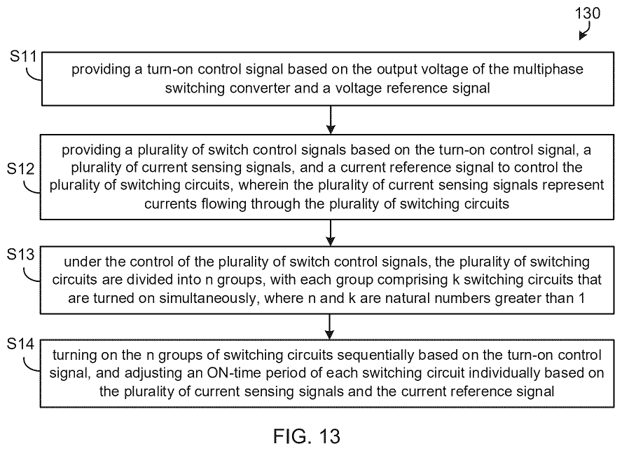

FIG. 13 illustrates a control method 130 for a multiphase switching converter in accordance with an embodiment of the present invention. The multiphase switching converter receives an input voltage at its input terminal and provides an output voltage at its output terminal. The multiphase switching converter comprises a plurality of switching circuits coupled in parallel between the input terminal and the output terminal to collectively provide the output voltage. The control method 130 comprises steps S11-S14.

At the step S11, providing a turn-on control signal based on the output voltage of the multiphase switching converter and a voltage reference signal. At the step S12, providing a plurality of switch control signals based on the turn-on control signal, a plurality of current sensing signals, and a current reference signal to control the plurality of switching circuits, wherein the plurality of current sensing signals represent currents flowing through the plurality of switching circuits. At the step S13, under the control of the plurality of switch control signals, the plurality of switching circuits are divided into n groups, with each group comprising k switching circuits that are turned on simultaneously, where n and k are natural numbers greater than 1. At the step S14, turning on the n groups of switching circuits sequentially based on the turn-on control signal, and adjusting an ON-time period of each switching circuit individually based on the plurality of current sensing signals and the current reference signal.

In one embodiment, turning on the n groups of switching circuits sequentially based on the turn-on control signal comprises: sequentially controlling rising edges of the n groups of switch control signals based on a plurality of pulses of the turn-on control signal, to regulate the output voltage to equal an output voltage setpoint defined by the voltage reference signal. In one embodiment, adjusting the ON-time period of each switching circuit based on the plurality of current sensing signals and the current reference signal comprises: based on a difference between each current sensing signal and the current reference signal, adjusting the falling edges of the corresponding switch control signal from the initial ON-time period, so as to control the current flowing through the corresponding switching circuit to equal a current setpoint defined by the current reference signal.

It should be noted that the execution order of the steps in the above flowchart is not limited to that shown in FIG. 13, and two consecutive functional blocks can be executed simultaneously, or in a reverse order.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

I/We claim:

1. A controller for a multiphase switching converter, comprising:
a turn-on control circuit configured to provide a turn-on control signal based on a voltage sensing signal representative of an output voltage of the multiphase switching converter and a voltage reference signal; and
a switch control circuit configured to generate a plurality of switch control signals to control the plurality of switching circuits based on the turn-on control signal and a plurality of current sensing signals representative of a plurality of currents flowing through a plurality of switching circuits of the multiphase switching converter; wherein
the switch control circuit is configured to regulate the plurality of switching circuits to operate in n groups, with each group comprising k switching circuits that are turned on at the same time, where n and k are integers greater than one; and wherein
the switch control circuit sequentially turns on the n groups of switching circuits in response to pulses of the turn-on control signal.

2. The controller of claim 1, wherein the switch control circuit is configured to turn off the plurality of switching circuits via the plurality of switch control signals based on an initial ON-time period and the plurality of current sensing signals.

3. The controller of claim 2, wherein the switch control circuit further comprises:
an ON-time control unit configured to provide a preset ON-time control signal for controlling the initial ON-time period; and
a turn-off control unit configured to provide a plurality of turn-off control signals based on the plurality of current sensing signals, a current reference signal, and the preset ON-time control signal; wherein
the switch control circuit is configured to turn off the plurality of switching circuits respectively based on the plurality of turn-off control signals.

4. The controller of claim 1, wherein the switch control circuit further comprises:
a group control unit configured to provide n group control signals based on the turn-on control signal, and to distribute the pulses of the turn-on control signal sequentially among the n group control signals; and
a switch control unit configured to generate the plurality of switch control signals based on the n group control signals and a plurality of turn-off control signals, wherein the plurality of turn-off control signals are generated based on an initial ON-time period and the plurality of current sensing signals, and wherein each group control signal is configured to turn on the k switching circuits within each group respectively, and each turn-off control signal is configured to turn off a corresponding switching circuit.

5. The controller of claim 4, wherein in response to differences between the plurality of current sensing signals and a current reference signal, the turn-off control unit is configured to provide corresponding turn-off control signals based on the initial ON-time period.

6. The controller of claim 1, wherein the switch control circuit is configured to advance or postpone falling edges of the plurality of switch control signals from an initial ON-time period based on differences between the plurality of current sense signals and a current reference signal.

7. The controller of claim 1, further comprising:
a voltage sensing pin configured to receive the voltage sensing signal;
a plurality of current sensing pins configured to receive the plurality of current sensing signals; and
a plurality of switch control pins configured to provide the plurality of switch control signals.

8. A controller for a multiphase switching converter, comprising:
a memory configured to provide a mode enable signal;
a turn-on control circuit configured to provide a turn-on control signal based on an output voltage of the multiphase switching converter and a voltage reference signal; and
a switch control circuit configured to provide a plurality of switch control signals to control a plurality of switching circuits of the multiphase switching converter based on the mode enable signal and the turn-on control signal; wherein
in response to a first status of the mode enable signal, the switch control circuit is configured to regulate the plurality of switching circuits to operate in n groups that are turned on in sequence based on the turn-on control signal, with each group comprising k switching circuits that are turned on at the same time, where n and k are integers greater than one.

9. The controller of claim 8, wherein the memory further comprises:
a turn-on mode register configured to provide the mode enable signal to determine whether the controller operates in a group turn-on mode during which the plurality of switching circuits operate in n groups.

10. The controller of claim 8, wherein in response to a second status of the mode enable signal, the switch control circuit controls the plurality of switching circuits to be turned on in an interleaved sequence, one after another, rather than being divided into n groups.

11. The controller of claim 8, wherein the switch control circuit is configured to adjust an ON-time period of each switching circuit based on a current flowing through the corresponding switching circuit.

12. The controller of claim 8, wherein the switch control circuit further comprises:
a turn-off control unit configured to generate a plurality of turn-off control signals based on the plurality of currents flowing through the plurality of switching circuits, a current reference signal and an initial ON-time period; wherein
the switch control circuit is configured to turn off the plurality of switching circuits respectively based on the plurality of turn-off control signals.

13. The controller of claim 12, wherein the turn-off control unit is configured to advance or postpone falling edges of the plurality of switch control signals from the initial ON-time period based on differences between the plurality of current sense signals and a current reference signal.

14. The controller of claim 8, wherein the switch control circuit further comprises:
a group control unit configured to provide a plurality of group control signals based on the turn-on control signal, wherein pulses of the turn-on control signal are distributed sequentially to the plurality of group control signals, a number of the plurality of group control signals is n;
an ON-time control unit configured to provide a preset ON-time control signal for controlling an initial ON-time period;
a turn-off control unit configured to generate a plurality of turn-off control signals based on a plurality of current sensing signals, a current reference signal, and the preset ON-time control signal; and
a switch control unit configured to generate the plurality of switch control signals based on the plurality of group control signals and the plurality of turn-off control signals.

15. The controller of claim 14, wherein the plurality of group control signals control rising edges of the plurality of switch control signals, and the plurality of turn-off control signals control falling edges of the plurality of switch control signals.

16. The controller of claim 8, wherein the switch control circuit further comprises:
a frequency dividing unit configured to provide a plurality of frequency dividing signals based on the turn-on control signal;
a group control unit configured to provide a plurality of group control signals based on the turn-on control signal, wherein there are fewer group control signals than frequency dividing signals; and
a plurality of sub-control units configured to provide the plurality of the switch control signals based on the plurality of frequency dividing signals and a plurality of turn-off control signals in response to a second status of the mode enable signal, and configured to provide the plurality of the switch control signals based on the plurality of group control signals and the plurality of turn-off control signals in response to the first status of the mode enable signal.

17. A multiphase switching converter, comprising:
an input terminal configured to receive an input voltage;
an output terminal configured to provide an output voltage;
a plurality of switching circuits coupled in parallel between the input terminal and the output terminal, for converting the input voltage to the output voltage;
a turn-on control circuit configured to provide a turn-on control signal based on a voltage sensing signal representative of the output voltage and a voltage reference signal; and
a switch control circuit configured to generate a plurality of switch control signals based on the turn-on control signal and a plurality of current sensing signals representative of a plurality of currents flowing through a plurality of switching circuits of the multiphase switching converter; wherein
the switch control circuit is configured to regulate the plurality of switching circuits to operate in n groups, with each group comprising k switching circuits that are turned on at the same time, where n and k are integers greater than one; and wherein
the switch control circuit sequentially turns on the n groups of switching circuits in response to pulses of the turn-on control signal.

18. The multiphase switching converter of claim 17, wherein the switch control circuit is configured to turn off the plurality of switching circuits via the plurality of switch control signals based on an initial ON-time period and the plurality of current sensing signals.

19. The multiphase switching converter of claim 18, wherein the switch control circuit further comprises:
an ON-time control unit configured to provide a preset ON-time control signal for controlling the initial ON-time period; and
a turn-off control unit configured to provide a plurality of turn-off control signals based on the plurality of current sensing signals, a current reference signal, and the preset ON-time control signal; wherein
the switch control circuit is configured to turn off the plurality of switching circuits respectively based on the plurality of turn-off control signals.

20. The multiphase switching converter of claim 17, wherein the switch control circuit further comprises:
a group control unit configured to provide n group control signals based on the turn-on control signal, and to distribute the pulses of the turn-on control signal sequentially among the n group control signals; and
a switch control unit configured to generate the plurality of switch control signals based on the n group control signals and a plurality of turn-off control signals, wherein the plurality of turn-off control signals are generated based on an initial ON-time period and the plurality of current sensing signals, and wherein each group control signal is configured to turn on the k switching circuits within each group respectively, and each turn-off control signal is configured to turn off a corresponding switching circuit.
